(19) United States
(12) Patent Application Publication
(10) Pub. No.: US 2010/0254256 A1
(43) Pub. Date: Oct. 7, 2010

(54) METHOD FOR EFFICIENTLY TREATING DISTURBANCES IN THE PACKET-BASED TRANSMISSION OF TRAFFIC

(75) Inventor: Götz Lichtwald, Walzbachtal-Wossingen (DE)

Correspondence Address: LERNER GREENBERG STEMER LLP, P O BOX 2480, HOLLYWOOD, FL, 33022-2480, US

(73) Assignee: Nokia Siemens Networks GmbH & Co KG, Muenchen (DE)

(21) Appl. No.: 12/721,226

(22) Filed: Mar. 10, 2010

Related U.S. Application Data
(63) Continuation of application No. 11/916,076, filed on Jan. 9, 2008, now abandoned.

(30) Foreign Application Priority Data
Jun. 2, 2005 (DE) 102005025419.5

(51) Int. Cl. H04L 12/26

(52) U.S. Cl. 370/218

(57) ABSTRACT

A method for efficiently treating disturbances in a packet-based transmission of traffic via a routing protocol and routing entities includes reporting the nonavailability of a neighboring routing entity to a routing entity with regard to the routing by means of the routing protocol, initiating the sending of a test message from the routing entity to the neighboring routing entity for determining availability, wherein, when the nonavailability is confirmed as part of the verification, a failure of the connection to the neighboring routing entity is assumed, and initiating a change in the routing for avoiding the failed connection by the routing entity when nonavailability of the neighboring routing entity is confirmed.

The invention relates to a method for efficiently treating disturbances in the packet-based transmission of traffic by means of a routing protocol.

The invention is in the field of Internet technologies or more specifically in the field of routing methods in packet-oriented networks and is aimed at the transmission of data under real-time conditions.

The currently most important development in the field of networks is probably the convergence of voice and data networks. An important future scenario is that data, voice and video information is transmitted via a packet-oriented network, wherein newly developed network technologies ensure that requirement features for different traffic classes are maintained. The future networks of various types of traffic will operate in packet-oriented manner. Current development activities relate to the transmission of voice information via networks conventionally used for data traffic, especially IP-(Internet Protocol) based networks.

To allow for voice communication via packet networks and particularly IP-based networks in a quality which corresponds to the voice transmission via circuit-switched networks, quality parameters such as, e.g. the delay of data packets or the jitter must be kept within narrow limits. In voice transmission, it is of great significance to the quality of the service provided that the delay times do not significantly exceed values of 150 milliseconds. To achieve a correspondingly short delay, improved routers and routing algorithms are being worked on which are intended to provide for more rapid processing of the data packets.

In the routing via IP networks, a distinction is usually made between intra-domain and inter-domain routing. In a data transmission via the Internet, networks—here also called subnetworks, domains or so-called autonomous systems—of various network operators are usually involved. The network operators are responsible for the routing within the domains which fall into their range of responsibility. Within these domains, they have the liberty of arbitrarily adapting the procedure in the routing in accordance with their own wishes as long as quality-of-service features can be maintained. The situation is different in routing between different domains in which different domain operators communicate with one another. Interdomain routing is made more complicated by the fact that, on the one hand, if possible, optimum paths to the destination are to be determined via different domains but, on the other hand, domain operators can locally apply strategies which influence a global calculation of optimum paths in accordance with objective criteria.

For example, a strategy consists in avoiding domains of network operators of a particular country for traffic with a particular origin. As a rule, however, this strategy is not known to all network operators having domains via which the traffic is routed, i.e. a network operator must locally make a decision with respect to the domain to which he forwards traffic without having complete information about the optimum path in the sense of a metric. These strategies are also frequently designated by the expression “policies”.

For routing between different domains, so-called exterior gateway protocols EGP are used. In the Internet, the border gateway protocol Version 4 (frequently abbreviated by BGP), more accurately described in RFC (Request for Comments) 1771, is currently used in most cases. The border gateway protocol is a so-called path vector protocol. A BGP entity (English-language literature frequently contains the expression “BGP speaker”) is informed by his BGP neighbors about possible paths to destinations to be reached via the respective BGP neighbor. Using path attributes, also reported, the BGP entity obtains the path to the available destinations which is in each case optimum from their local perspective. As part of the BGP protocol, four types of messages are exchanged between BGP entities, among these a so-called update message by means of which path information is propagated through the entire network and which allows the network to be optimized in accordance with topology changes. Sending out update messages usually leads to an adaptation of the path information in all BGP entities of the network in the sense of a routing optimized in accordance with the locally available information. Apart from this, so-called keepalive messages play a role by means of which a BGP entity informs his BGP neighbors about his operability. When these messages are lacking, the BGP neighbors assume that the link to the BGP entity is disturbed.

The propagation of topology information with the aid of the BGP protocol has the disadvantage that in the case of frequent change notices, a considerable load of the messages propagated through the network for indicating the change occurs and that the network does not converge out if change notices follow one another too rapidly. This problem that the network does not converge out or that the interdomain routing does not become stable has been approached by the so-called route-flap damping approach. The idea with respect to this concept is to verify the indication of a change by a BGP neighbor with a sanction. When a change notice is received, the damping parameter is increased and when a threshold is exceeded by the damping parameter, change messages are ignored. The damping parameter decreases exponentially with time. As a consequence, change messages are ignored by BGP entities as long as the damping value has not dropped below the lower threshold (reuse threshold).

However, the method has the disadvantage that it entails a risk of potential loss of connection which is not tolerable for real-time traffic.

Having regard to the transmission of real-time traffic, current developments of interdomain routing aim for a more rapid detection and elimination of disturbances.

In the RFC draft “Bidirectional Forwarding Detection” by D. Katz and D. Ward and in the publication “Improving Convergence Time of Routing Protocols” by G. Lichtwald, U. Walter and M. Zitterbart (3rd International Conference on Network, 29.02.-04.03., Guadelope, ISBN 0-86341-326-9), protocols for accelerated detection of disturbances are described. Both approaches propose a protocol separate from the routing protocol, for monitoring the connectivity and for detecting disturbances. This procedure allows the temporal granularity of the monitoring to be adapted to the network conditions (loading by monitoring packets) and the transmission services carried out in the network (real-time capability required or not).

In EP 1453250, an approach to supplementing the BGP protocol by a method for rapid response to link failures in interdomain routing is described. This approach provides the provision of substitute paths where no prior propagation of change notices through the entire network is required. The routing is only changed along substitute paths. This restricted modification of the routing allows rapid response to the disturbances. In the case of persistent error, a topology adaptation can be additionally performed in the network by means of the BGP protocol.

The invention has the object of rendering more efficient the response of packet-based networks to error messages.

The object is achieved by a method as claimed in claim 1.

The invention is based on the finding that in many cases technologies or protocols with fault detection and fault eliminating mechanisms which lead to two separate mutually independent responses are used simultaneously. In this context, these responses can occur in different time scales and differ greatly in the resultant network loading. The invention is aimed at suppressing slow and elaborate fault elimination mechanisms if a mechanism used in parallel leads to fault recovery or if the fault is of such a short duration that elimination in the time scale of the fault recovery mechanism is not meaningful.

For example, the BGP protocol, which is cumbersome with respect to fault recovery, is used together with the OSPF protocol or the MPLS protocol (multi protocol label switching). Both protocols have mechanisms for fault recovery with a response time which is more rapid in comparison with the BGP protocol. The invention is aimed at such constellations.

According to the invention, a routing entity responds to a message of non-availability of a neighbor routing entity with regard to the routing by means of a routing protocol by sending a test message to the neighboring routing entity in order to verify the non-availability or the loss of connectivity. It is only if there is no positive return message with regard to the availability that a change in routing is initiated in order to avoid the failed connection to the neighboring routing entity. The term “neighboring routing entity” is to be understood to mean that this is a neighbor or “next hop” in the sense of the routing protocol. It does not necessarily need to be a neighborhood with regard to the physical communication infrastructure. A neighboring routing entity can also be an adjacent autonomous system in interdomain routing.

The invention leads to a more efficient use of the existing resources in fault recovery. Fault recovery or a change in routing by means of the routing protocol is avoided in three important cases in which such a change is not necessary:

The fault consists in a short-term instability which no longer exists when the test message is sent. Such instabilities can trigger the routing convergence process which entails a global (in the sense of the Internet) loading of the network by update messages, particularly in the case of BGP.

The fault was already eliminated by a mechanism used in parallel and responding to a more rapid timescale at the time the test message was sent.

The fault was pretended by a fault message in order to disturb the system.

Nonavailability can be found, for example, by means of the test message in that a time interval is predetermined for a response (e.g. mirrored test message) and when there is no response within the time interval, nonavailability is assumed. The time interval can be adapted to the situations of the system (e.g. measured delay times, traffic-type-related requirements with respect to the response time to faults). As an alternative, protocol-related fault messages can be used in the transmission of the test message. For example, the TCP (Transport Control Protocol) signals when a transmission is not successful. As a rule, however, such a procedure is less flexible.

The invention is preferably used in inter-domain routing where there is a problem of a comparatively slow response of EGP protocols and a greater risk of manipulated messages. When the fault is confirmed, there would be, for example, a response by the EGP protocol (BGP, as a rule). According to a development, the invention is combined with the procedure described in EP 1453250. In this context, paths interrupted by the disturbance, which contain autonomous systems to be traversed, are assumed. A substitute path to a destination point is then taken into operation. For this purpose, routing domains located on the substitute path are notified. The routing domains notified which are located on the substitute path adjust their interdomain routing in accordance with a routing to the destination along the substitute path until all routing domains on the substitute path have adjusted their interdomain routing in accordance with a routing on the substitute path to the destination. This procedure minimizes the changes made in the routing. A more elaborate adaptation of the entire topology can be carried out if the fault proves to be a persistent error.

However, the method can also be used just as well within an autonomous system or for intradomain routing. Fault responses can consist of a network-wide topology change (e.g. OSPF), in the provision of a substitute path for a failed path (e.g. as part of the MPLS concept) or of a local response (e.g. as described in WO2004/051957).

The invention also comprises a device, e.g. router, which comprises a routing entity and is arranged for carrying out a method according to the invention for efficiently treating disturbances in the packet-based transmission of traffic. In this arrangement, a routing entity can be given both by a router and by a software implementation of routing functions on suitable hardware.

In the text which follows, the subject matter of the invention is described in greater detail in the context of an exemplary embodiment, with reference to figures, in which:

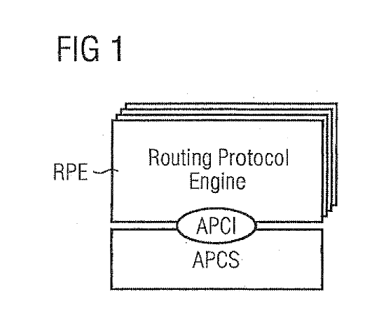

FIG. 1 shows a section of a routing architecture.

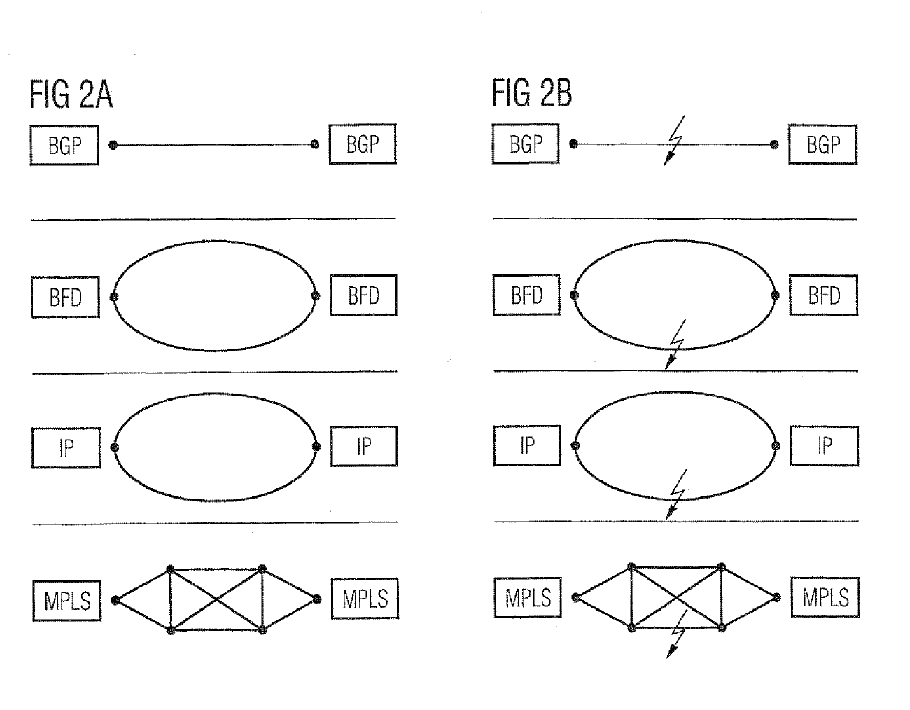

FIGS. 2a and 2b show a protocol stack with various mechanisms for fault recovery.

FIG. 1 diagrammatically shows the interaction of a model or a protocol entity APCS (adjacent peer check service) with a routing protocol engine (RPE) which communicate with one another via an APCI (adjacent peer check interface) provided for this purpose. Such a routing architecture has been used, for example, in the document quoted in the introduction to the description “Improving Convergence Time of Routing Protocols” by G. Lichtwald, U. Walter and M. Zitterbart. The routing protocol is, e.g. the BGP protocol. The BGP protocol provides periodic KEEPALIVE messages with a period of usually 60 seconds for testing the connectivity. If KEEPALIVE messages cannot be delivered, a fault message occurs. According to the invention, the protocol entity APCS would then be occasioned via the APCI interface to send a test message or check message.

FIGS. 2a and 2b show various layers of a network. The bottom layer is the MPLS (multiprotocol label switching). On the basis of the MPLS paths, a logical IP topology is established. This topology is not equal to the MPLS topology and “sees” fewer network components, i.e. a part of the network components active at the MPLS level are transparent at the IP level. The BFD (Bidirectional Forwarding Detection) service is based in this example on the view of the IP layer. For the border gateway protocol, the two redundant paths of the IP layer are transparent. The BGP protocol only “sees” the direct session with its BGP neighbor.

It is assumed in this example that the failed link in FIG. 2b is the link via which the BGP session was established. The BFD protocol reports the failure to the BGP router in the sub-second range. This conventionally leads to the BGP protocol starting the convergence process.

When a mechanism described here is used, the convergence process does not mandatorily become necessary since the BGP protocol, before initiating the convergence process, checks by means of the check message with its BGP neighbor whether it is actually not available. Modern MPLS versions allow a rapid switch-over to back-up paths in comparison to the BGP fault response. In this case, the check message establishes connectivity because the more rapid MPLS response was preceded by a fault response. The BGP mechanism for fault recovery is not triggered then.

As a result, the load in the Internet can be lowered significantly. It is also possible to use this mechanism to detect links propagated as not available falsely or abusively and thus to prevent, for example, hijacking—that is to say the unauthorized appropriation of a data path—of a route.

1-10. (canceled)

11. A method for efficiently treating disturbances in a packet-based transmission of traffic via a routing protocol and routing entities, comprising the steps of: reporting the nonavailability of a neighboring routing entity to a routing entity with regard to the routing by means of the routing protocol; initiating the sending of a test message from the routing entity to the neighboring routing entity for determining availability, wherein when the nonavailability is confirmed as part of the verification, a failure of the connection to the neighboring routing entity is assumed; and initiating a change in the routing for avoiding the failed connection by the routing entity when nonavailability of the neighboring routing entity is confirmed.

12. The method as claimed in claim 11, wherein a time interval for response to the test message is given, and wherein, when the response does not occur within the time interval, nonavailability of the neighboring routing entity is determined.

13. The method as claimed in claim 11, wherein the routing protocol is an interdomain routing protocol, and the routing entities are interdomain routing entities.

14. The method as claimed in claim 13, wherein paths are given by routing domains to be passed towards the destinations.

15. The method as claimed in claim 14, wherein the change in routing occurs in the form of a path change by taking into operation a back-up path to a destination, and wherein: routing domains located on the back-up path are notified; and notified routing domains which are located on the back-up path adjust their interdomain routing in accordance with routing to the destination along the back-up path until all routing domains on the back-up path have adjusted their interdomain routing in accordance with a routing on the back-up path to the destination.

16. The method as claimed in claim 13, wherein the change in routing occurs in the form of a path change as part of a topology change initiated by network-wide propagation of messages.

17. The method as claimed in claim 11, wherein the routing protocol is an intradomain routing protocol, and the routing entities are intradomain routing entities.

18. The method as claimed in claim 17, wherein the change in routing occurs in the form of a path change by providing a back-up path.

19. The method as claimed in claim 17, wherein the change in routing occurs in the form of a path change as part of a topology change initiated by propagation of messages within the domain.
